(19) United States
(12) Patent Application Publication
(10) Pub. No.: US 2022/0179062 A1
(43) Pub. Date: Jun. 9, 2022

(54) DETECTION APPARATUS AND METHOD

(71) Applicant: ESSENCE SECURITY INTERNATIONAL (E.S.I.) LTD., Herzlia Pituach (IL)

(72) Inventor: Ohad Amir, Herzlia Pituach (IL)

(21) Appl. No.: 17/602,238

(22) PCT Filed: Apr. 3, 2020
(86) PCT No.: PCT/IL2020/050408

§ 371 Date: Oct. 7, 2021

(30) Foreign Application Priority Data
Apr. 8, 2019 (IL) 265930

(51) Int. Cl. G01S 13/88; G01S 13/04; G01S 7/35; G01S 7/41

(52) U.S. Cl. CPC G01S 13/887; G01S 13/04; G01S 13/89; G01S 7/415; G01S 7/354

(57) ABSTRACT

A detection apparatus (1000) comprises radar apparatus (100, 110) to direct radar signals to a body and receive radar reflections from at least a portion of the body. The apparatus (100) also comprises one or more processors (120) to process the received radar reflections to determine a difference between a spatial distribution of the radar reflections and at least one reference to detect a presence of an object of interest as a radar reflective component of the body or a radar absorptive component of the body. The at least one reference is based on a spatial distribution of radar reflections from at least a portion of at least one reference object.

### RELATED APPLICATION

This application claims the benefit of priority of Israel Patent Application No. 265930 filed on 8 Apr. 2019, the contents of which are incorporated herein by reference in their entirety.

### FIELD OF THE INVENTION

The present invention relates generally to a detection apparatus and method for detecting the presence of an object of interest on a body.

### BACKGROUND INFORMATION

The detection of an object of interest carried by a body is of particular interest for security, such as airport or building security, where it is necessary to detect whether restricted objects are being carried by a person.

Typically, personal security screening requires the person to enter a scanning machine or pass through a scanning area or be manually inspection. This is usually done individually and is hence a slow labour intensive process.

### SUMMARY OF THE INVENTION

The present invention provides a detection apparatus comprising radar apparatus to direct radar signals to a body and receive radar reflections from at least a portion of the body; and one or more processors to process the received radar reflections to determine a difference between a spatial distribution of the radar reflections and at least one reference to detect a presence of an object of interest as a radar reflective component of the body or a radar absorptive component of the body, wherein the at least one reference is based on a spatial distribution of radar reflections from at least a portion of at least one reference object.

The present invention also provides a detection method comprising controlling a radar apparatus to direct radar signals to a body and receive radar reflections from at least a portion of the body; and processing the received radar reflections to determine a difference between a spatial distribution of the radar reflections and at least one reference to detect a presence of an object of interest as a radar reflective component of the body or a radar absorptive component of the body based at least in part on an indication, wherein the at least one reference is based on a spatial distribution of radar reflections from at least a portion of at least one reference object.

### BRIEF DESCRIPTION OF THE SEVERAL VIEWS OF THE DRAWINGS

FIG. 1A is a schematic diagram illustrating a human body used as a reference body and indications of radar reflections therefrom in accordance with embodiments;

FIG. 1B is a schematic diagram illustrating a human body carrying an object of interest having a high radar reflectivity and indications of radar reflections therefrom in accordance with one or more embodiments;

FIG. 2 is a schematic diagram illustrating a detection apparatus in accordance with one or more embodiments;

FIG. 3 is a schematic diagram illustrating a detection apparatus in accordance with one or more alternative embodiments;

FIG. 4 is a flow diagram illustrating a detection method in accordance with one or more embodiments;

FIG. 5A is a schematic diagram illustrating a human body used as a reference body and indications of radar reflections therefrom and a centre of radar reflections for at least a portion of the body in accordance with embodiments;

FIG. 5B is a schematic diagram illustrating a human body carrying an object of interest having a high radar reflectivity and indications of radar reflections therefrom and a centre of radar reflections for at least a portion of the body in accordance with one or more embodiments;

FIG. 6A is a schematic diagram illustrating the radar energy for respective reflections from a human body used as a reference body and the determined average and peak energy using in the determination in accordance with one or more embodiments;

FIG. 6B is a schematic diagram illustrating the radar energy for respective reflections from a human body carrying an object of interest and the determined average and peak energy using in the determination in accordance with one or more embodiments;

FIG. 7A is a schematic diagram illustrating a human body used as a reference body and indications of radar reflections therefrom in defined portions of the body for use in radar reflection magnitude determination in accordance with embodiments; and

FIG. 7B is a schematic diagram illustrating a human body carrying an object of interest having a high radar reflectivity and indications of radar reflections therefrom in defined portions of the body for use in radar reflection magnitude determination in accordance with embodiments.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

In the following embodiments, like components are labelled with like reference numerals.

In the following embodiments, the term data store or memory is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., solid state drives, random-access memory (RAM), etc.), and/or the like.

The functions or algorithms described herein are implemented in hardware, software or a combination of software and hardware in one or more embodiments. The software comprises computer executable instructions stored on computer readable carrier media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

As used herein, except wherein the context requires otherwise, the terms “comprises”, “includes”, “has” and grammatical variants of these terms, are not intended to be exhaustive. They are intended to allow for the possibility of further additives, components, integers or steps.

One or more generalized embodiments of the invention provides a detection apparatus comprising radar apparatus to direct radar signals to a body and receive radar reflections from at least a portion of the body; and one or more processors to process the received radar reflections to determine a difference between a spatial distribution of the radar reflections and at least one reference to detect a presence of an object of interest as a radar reflective component of the body or a radar absorptive component of the body, wherein the at least one reference is based on a spatial distribution of radar reflections from at least a portion of at least one reference object.

One or more generalized embodiments of the invention provides a detection method comprising controlling a radar apparatus to direct radar signals to a body and receive radar reflections from at least a portion of the body; and processing the received radar reflections to determine a difference between a spatial distribution of the radar reflections and at least one reference to detect a presence of an object of interest as a radar reflective component of the body or a radar absorptive component of the body, wherein the at least one reference is based on a spatial distribution of radar reflections from at least a portion of at least one reference object.

One or more embodiments of the invention is applicable to the detection of any radar reflective object or radar absorptive object carried by a moving body. A radar reflective object might typically be a metal object, such as a knife or a gun. A radar absorptive object may be an illicit or illegal object e.g. a radar reflective object, concealed in a radar absorptive material, casing or cover in an attempt to conceal the radar reflective object or some other radar absorptive substance. The body can be any type of body, including a human or animal. The radar absorptive or reflective object being detected can be detected since it changes the expected distribution of radar reflections from the at least one portion of the body, since the radar reflections from the region of the body where the object is located are either higher or lower in intensity or magnitude than would be expected from the body. The expected distribution of radar reflections from the at least one portion of the body can be based on a reference object.

In one or more embodiments the detection apparatus and method processes the radar reflections to include movement of the body as part of the determination of the difference between a spatial distribution of the radar reflections and at least one reference. For example, a body may be tracked by identifying a cluster of radar reflections for which a centre of the reflections moves over successive scan frames. A Kalman filter may then be used to determine the next position of the target based on the corresponding cluster of measurements and the prediction of the next position based on the previous position and other information, e.g. the radial previous velocity. The previous radial velocity may be derived for example from a doppler signal that determined from the received radar reflections. By using a Kalman filter or other measurement methods that temporally accumulate measurements, more data on the spatial distribution of radar reflection magnitudes can be gathered, despite movement of the body, which may aid in identifying the reflective of absorptive objects of interest in moving bodies.

Further, in some embodiments, the radar reflection signals may be filtered so that only moving objects are detected. This may be used to disregard non-moving objects as being non-threatening, or not of interest, bearing in mind that an alive person will generally produce at least some radar detectable movement even when the person is trying to be stationary.

One or more embodiments of the present invention determine whether a spatial distribution of radar reflections for at least a portion of a body is different to a distribution of radar reflections from at least a portion of one or more reference objects in order to detect an object of interest.

In one or more embodiments, the or each reference can be obtained from radar detections from at least a portion of at least one reference object or the or each reference can be obtained from simulations or as a result of processing radar detections from objects to determine a notional reference object or objects and one or more portions thereof. The or each reference is in some embodiments provided from stored and accessed data locally for reliability and/or minimal latency. In an alternative embodiment, the or each reference may be stored and accessed remotely. To enable more accurate comparisons of received radar reflections with a reference, a plurality of references can be used e.g. stored for comparison. For example, references can be provided for differently shaped and sized objects e.g. for humans, there can be different references for adults and children, and/or for different genders.

In one or more embodiments, the or each reference object can comprise a human body and the body can comprise a human body so that the process is aimed at detecting objects carried by people. This is particularly applicable to the field of security where it is desirable to be able to detect objects that might be a security threat carried by people moving around a detection region. The use of radar enables the region to not be as confined in prior art security screening methods and also allows the scanning of people in motion i.e. it does not require them to stand still and assume any sort of pose as currently required by some prior art security screening system.

In one or more embodiments, the difference can be determined by determining a location of a centre of radar reflections from the at least a portion of the body and comparing the centre of radar reflections from the at least a portion of the body to a centre of radar reflections for the or each reference. The centre of radar reflections is calculated taking both the spatial distribution of the radar reflections and the magnitude of the radar reflections into account. This may be in the form of a weighting of each reflection based on the magnitude of each reflection.

In one or more embodiments, the difference can be determined by comparing a peak radar measurement magnitude to average radar measurement magnitude ratio for the radar reflections from the at least a portion of the body with at least one reference peak radar measurement magnitude to average radar measurement magnitude ratio. Each radar measurement magnitude, is in some embodiments, a radar cross section magnitude, which compensates for distance between the radar device and the location of reflection. In other embodiments, each radar measurement magnitude is the proportional to, or otherwise correlated with, the absolute value of the received radar reflection (i.e. without distance compensation). For example, each radar measurement magnitude may be correlated with an amount of reflected radar energy, and for ease of understanding the invention will herein after be described as such, bearing in mind that other characterizations of the received reflected radar signal may alternatively be used.

Highly radar reflective objects in the region of a portion of the body (i.e. objects significantly more radar reflective that human tissue or clothing, e.g. metal) will distort the peak radar reflected energy in the area, so that although the average energy will go up or down, it will not be as affected as much as the peak energy reflected by the object. On the other hand, if an object carried on the body is reflective but not the most reflective object on the body, then the peak will be the same, but the average will go up, thus decreasing the peak to average ratio. Alternatively, if an object carried on the body is highly absorptive, the peak will be the same, but the average over the body or the relevant part of the body will be reduced, thus leading to an increase in the peak to average ratio.

Hence, the presence of a highly reflective or absorptive (“high” being different to, or different by more than an order of magnitude to, a human body) object of interest can change the ratio, and this can be used for determining a difference in the spatial distribution of radar reflections and hence detection of the object. In one or more embodiments, the at least one reference peak energy to average energy ratio can be derived from a spatial distribution of radar reflections from at least a portion of at least one reference object.

In one or more embodiments, the difference can be determined by processing the spatial distribution of the radar reflections to determine at least one value representative of the distribution and comparing the at least one value with at least one reference value derived from at least one spatial distribution of the radar reflections for at least one reference object. The or each value can for example comprise a peak to average energy value. The value can comprise any value that can be calculated to code the spatial distribution of the radar reflections.

In other embodiments, as an alternative to representing the spatial distribution as a peak to average energy ratio, in other embodiments, the spatial distribution may be represented a peak to median energy ratio.

In other embodiments, the calculated spatial distributions that are compared may be correlated with a variance in energy with respect to a spatial dimension. For example, a calculated spatial distribution be a calculated standard distribution of the different magnitudes of measured energy received from different points on the body. For example, a variance or standard distribution of a measurement of a body with a highly reflective object on the body may be significantly greater than a variance or standard distribution of a reference that is representative of person without such an object. A highly absorptive object on the body may also result in an increase the variance of standard deviation of the measurements.

In one or more embodiments, the difference can be determined by processing the spatial distribution of the radar reflections to determine magnitudes derived from radar reflections from portions of the object and comparing the magnitudes to determine one or more ratios and comparing the one or more ratios with one or more reference ratios. In one or more embodiments, the magnitudes derived from radar reflections can be calculated as respective RCS estimates.

In one or more embodiments, an output signal indicative of the difference can be generated. The signal can cause an output to a user to be generated or it can be a control signal to cause an internal operation of a machine. In one or more embodiments, the signal is output when the difference exceeds a threshold. In one or more embodiments, the signal can be output as an image illustrating the difference as a spatial distribution difference. The spatial distribution difference comprises a two-dimensional image of the differences in received radar reflections from the at least one portion of the body.

In one or more embodiments, a plurality of references are available for differently shaped and/or sized objects and a selection of at least one reference for use in the difference determination can be received, for example based on an input by an operator. For example, an operator of a detection system may recognize that a person being to be scanned by the detection apparatus is an obese adult and therefore they can assist the detection system by entering a selection of a reference for an obese adult.

In one or more embodiments, radar reflections are received from the at least a portion of the body in repeated scan frame times and the radar reflections are accumulated from a plurality of successive scan frame times to determine the difference between the spatial distribution of the radar reflections and the at least one reference. For example, in some embodiments a relatively low resolution of the radar may result in few measurement points from a body of interest in a single scan (i.e. frame, also referred to herein as a scan frame). To enable more points to be accumulated to enable or improve correlating measurements points to locations on a map of a reference human body, multiple scans may be accumulated over a window of time, which may have a predefined duration. A scan can comprise a time period during which a frequency range is scanned through.

Additionally, or alternatively, the number of measurement points can be increased to enable and/or improve correlation to a map of a reference human body by increasing the resolution of the radar measurements, e.g. by increasing the number of antennas.

In one or more embodiments, the detection apparatus can comprise, or be, a handheld device for convenience and/or adaptability of use inside or outside of a security environment.

Specific embodiments will now be described with reference to the drawings.

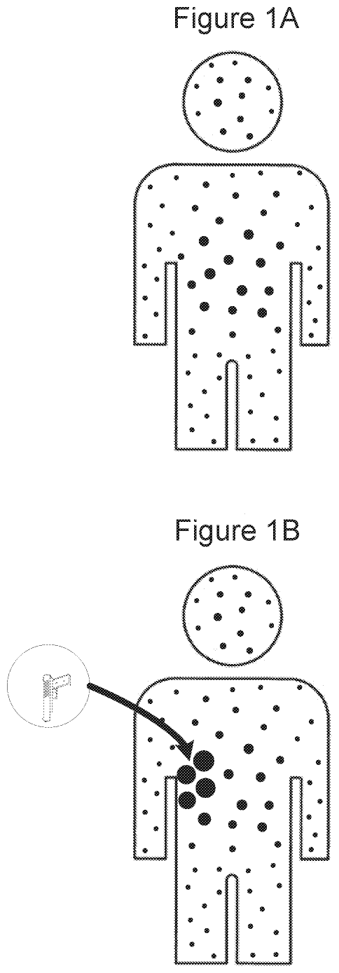

FIG. 1A is a schematic diagram illustrating a human body used as a reference body and indications of radar reflections therefrom in accordance with embodiments.

For each radar measurement, for a specific time in a series of time-spaced radar measurements, the radar measurement may include a set of one or more measurement points that make up a “point cloud”. Each point in the point cloud may be defined by a 3-dimensional spatial position from which a radar reflection was received, and defining a peak reflection value, and a doppler value from that spatial position. Thus, a measurement received from a radar-reflective object may be defined by a single point, or a cluster of points from different positions on the object, depending on its size.

The figure illustrates a map of radar reflections. These points may represent actual radar reflections obtained from averaging radar reflection magnitudes from training bodies or points calculated based on a notional body. The size of the point represents the intensity (magnitude) of energy level of the radar reflections. Different parts or portions of the body reflect the radar signal differently. For example, generally, reflections from areas of the torso are stronger than reflections from the limbs. Each point represents coordinates within a bounding shape for each portion of the body. Each portion can be separately considered and have separate boundaries, e.g. the torso and the head may be designated as different portions. The point cloud can be used as the basis for a calculation of a reference parameter or set of parameters which can be stored instead of or in conjunction with the point cloud data for a reference object (human) for comparison with a parameter or set of parameters derived or calculated from a point cloud for radar detections from an object (human) to be subject to a security check, such as illustrated in FIG. 1B. As used herein, the term “scan” does not necessarily necessitate a moving a beam. Indeed, in a preferred embodiment, the radar signals are generated by scanning through a range of frequencies that constitute that radar bandwidth in order to determine distances (range) and doppler values to points of reflection, and this is done with simultaneously operating antennas, whereby the reflections are received on at least 3 receiving antennas, but more preferably at least 4 receiving antennas, to determine locations of reflection in at 3 dimensions. Preferably there are also at least 4 transmitting antennas. In some embodiments, for higher location resolution, more than 4 receiving antennas and/or more than four transmitting antennas are used. For example, there may be 16 receiving antennas and 16 transmitting antennas, which can be used to provide 64 virtual antennas/phase detectors.

FIG. 1B is a schematic diagram illustrating a human body carrying an object of interest having a high radar reflectivity (relative the person's body) and indications of radar reflections therefrom in accordance with one or more embodiments.

In this embodiment the object carried by the body is a gun, and the gun is carried on the torso. The metal of the gun causes an increase in radar reflections from the region of the torso where the gun is located.

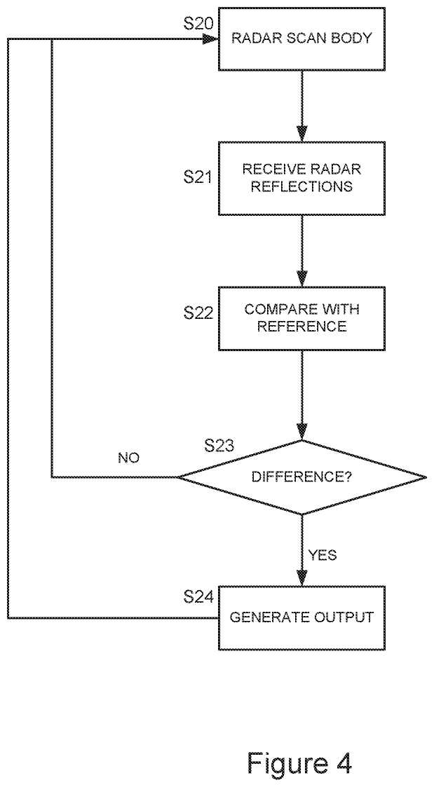

In order to detect that the body is carrying an object of interest, such as a gun, the radar reflections from the point cloud illustrated in FIG. 1B can be processed for the determination of a difference in the spatial distribution of the radar reflections relative to the radar reflections for a reference body as illustrated in FIG. 1A. The method of carrying this out will be described herein after with reference to FIGS. 4 to 7.

In the embodiment illustrated in FIG. 1B, the relative magnitude of radar reflection measurements is depicted based on the size of the point. In this figure, the object is radar reflective and hence there is an increase in magnitude of the radar reflection points from the region in which the object is located. Conversely the object could be radar absorptive and there would then be a decrease in radar reflections in the region in which the object is located. In both cases there is a change in the spatial distribution of the energy in the point cloud for the body or for a portion of the body on the vicinity of the object. In other words, there is an unexpected distribution of radar reflections compared to what is expected i.e. a reference. The object could be small, occupying only a part of a region of a body e.g. a part of the torso as illustrated in FIG. 1B. Alternatively, the object could be large, occupying all of a portion and part of another portion e.g. all of the torso and part of the head.

The body to be scanned for object detection can be of varying shapes, sizes and poses. For example, the body may be a child or an adult. The body may be a thin tall person or a short obese person. The person may be standing/walking, sitting or bending over. While the parameters calculated from the point cloud can desensitize the reference to scale or size, the different shapes of the body or the way the different portions of the body are viewed by the radar scan may in some cases influence the measured spatial distribution of radar measurement magnitudes. Hence, in one or more embodiments, a plurality of references can be used. Each reference can comprise parameters derived from a different reference body shape or pose. The radar reflections (or parameters derived from the radar reflections) from the scanned body can hence be compared against a number of reference bodies, or an operator can select a reference body (reference parameters) for comparison by observing the shape or pose of the target body to be radar scanned and selecting an appropriate reference to assist with more accurate detection of an object of interest.

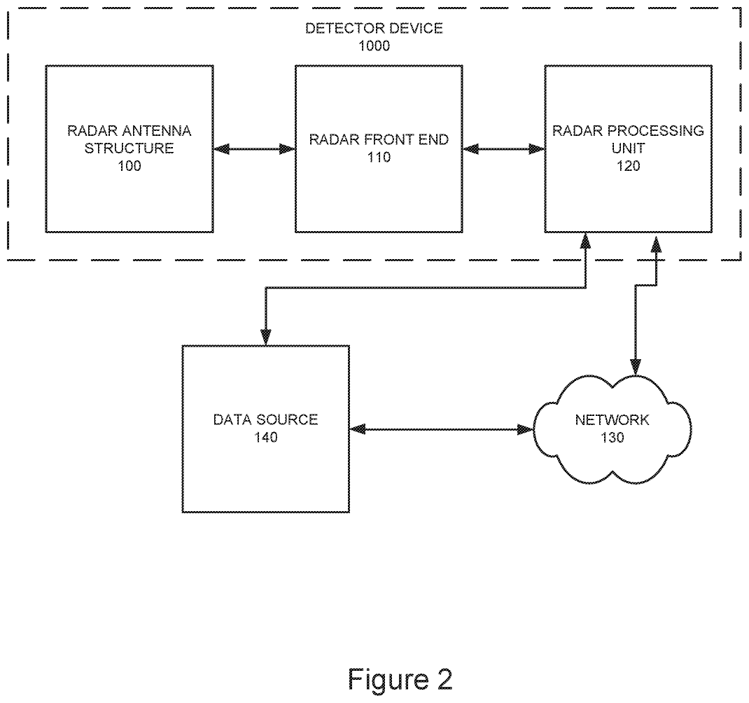

FIG. 2 is a schematic diagram illustrating a detection apparatus in accordance with one or more embodiments. The system can comprise distributed components or it can comprise components provided in a single device.

An exemplary detection apparatus includes a radar apparatus comprising a radar antenna structure 100 and a radar front end 110 for the exchange of signals for the transmission and reception of radar signals with the radar antenna structure 100. The radar signals are transmitted as electromagnetic waves from a plurality of antennas of the radar antenna structure 100 and received by another plurality of antennas of the radar antenna configuration 100 as reflected electromagnetic waves.

The radar is in some embodiments continuous-wave radar, such as frequency modulated continuous wave (FMCW) technology. Such a chip may be, for example, Texas Instruments Inc. part number IWR1443 or IWR6843 for 3D radar. The radar may operate in microwave frequencies, e.g. in some embodiments a carrier wave in the range of 1-100 GHz (76-81 Ghz or 57-64 GHz in some embodiments), and/or radio waves in the 300 MHz to 300 GHz range. In some embodiments, the radar has a bandwidth of at least 1 GHz.

A radar processing unit 120 is connected to the radar front end 110 or, more broadly to the radar apparatus, to process the radar signals. The radar processing unit 120 can comprise one or more processors programmed in accordance with program code stored on storage medium (not shown) to perform the method as described herein after with reference to FIGS. 4 to 7.

The radar processing unit 120 communicates with a data source 140 containing reference data for one or more reference bodies. The communication can be directly between the radar processing unit 120 and the data source 140, or the connection can be over a data or communications network 130, such as a local network (LAN), a wide area network (WAN) or the internet. Hence, the data source 140 can be provided locally or remotely. The data source 140 can be used by multiple detection apparatuses as a source of reference data.

In one or more embodiments, the radar antenna structure 100, the radar front end and the radar processing unit 120 may be provided in a single detector device 1000 indicated by the dashed line or even a single ship, and the device can comprise, or in some embodiments be, a handheld or portable (e.g. wearable) device. For example, the detector device 1000 may be a radar gun that can be pointed to have its field of view containing a person of interest so as to receive radar measurements for that person. The data source 140 can also be provided in the detector device 1000 in one or more embodiments.

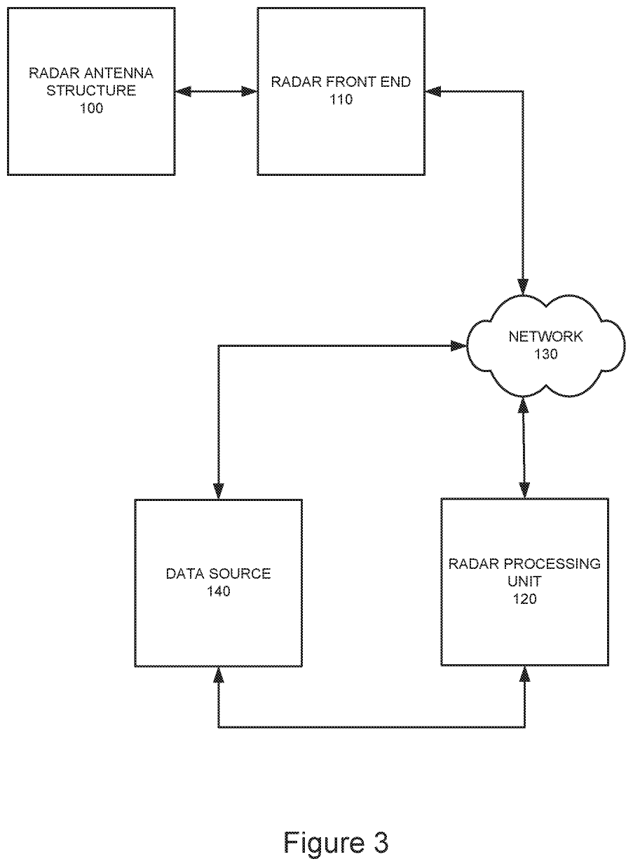

FIG. 3 is a schematic diagram illustrating a detection apparatus in accordance with one or more alternative embodiments.

This embodiment is similar to the embodiment of FIG. 2 except that the apparatus is more distributed. In this embodiment, the radar processing unit 120 is arranged remotely from the radar front end 110 and the radar antenna structure 100. Communication between the radar processing unit 120 and the radar front end 110 of the radar apparatus is over a communications or data network 130. Hence, in this embodiment, the radar apparatus comprising the radar antenna structure 100 and the radar front end 110 is separated, by a network 130, from the one or more processors performing the processing of the radar reflections. The embodiment in FIG. 2, however, may provide a solution with better reliability and reduced latency.

The radar processing unit 120 communicates with a data source 140 containing reference data for one or more reference bodies. The communication can be directly between the radar processing unit 120 and the data source 140, or the connection can be over the data or communications network 130, such as a local network (LAN), a wide area network (WAN) or the Internet. Hence, the data source 140 can be provided locally or remotely to the radar processing unit 120. The data source 140 can be used by multiple detection apparatuses as a source of reference data. Nonetheless, for speed and reliability of operation, consolidated hardware, like in FIG. 2, is advantageous over a distributed system like in FIG. 3.

FIG. 4 is a flow diagram illustrating a detection method in accordance with one or more embodiments.

In step S20 the radar antenna unit 100 and the radar front end 110 operate as a radar apparatus to direct radar signals to a body and in step S21 radar reflections are received.

In step S22 the radar reflections are processed for a scan to determine a difference between them and at least one reference. This can in one or more embodiments be by comparing one or more parameters derived from the radar signals with one or more reference parameters. If the processing determines that there is no difference (step S23) the process returns to step S20 for another scan. If the processing determines that there is a difference, in step S24 a further operation is performed, such as the generation of an output by the detection apparatus.

In one or more embodiments, the steps S20 and S21 can be repeated for several scan frame times and the repeated radar reflections can be accumulated from a plurality of successive scan frame times to enable more points to be accumulated or to improve the signal from the points in the event that the radar reflections from the body are weak from a single scan.

The processing of the radar signals in step S21 can, in one or more embodiments, include the processing taking into account movement of the body, by for example using the doppler signals and/or a Kalman filter, to track the movement of the body.

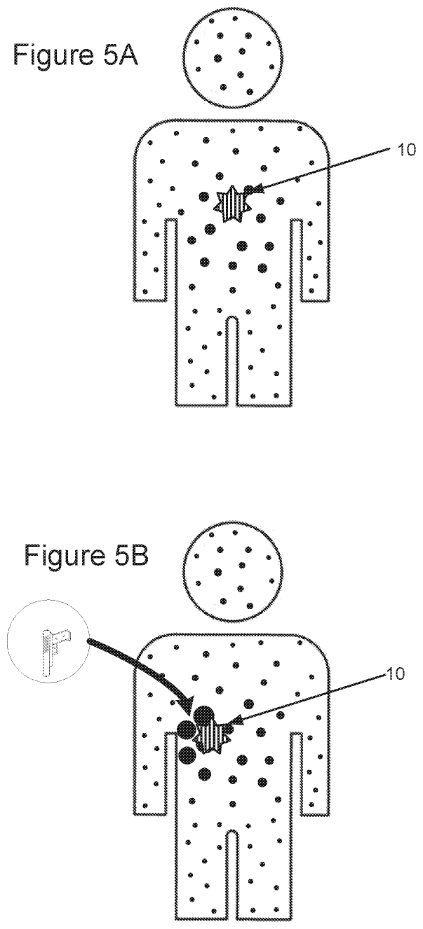

The processing to determine whether or not there is a difference can be undertaken to determine whether there is a difference which is greater than some sort of threshold. Details of difference method for performing the processing will be described herein after with reference to FIGS. 5 to 7.

The output generated by the detection apparatus and method can comprise any further operation internal to a system or external to the system. For example, in one or more embodiments, the output may be a visible or audible output indicating that a difference has been detected and hence there is a likelihood that the scanned body is carrying an object of interest. The visible or audible output can hence warn an operator to take appropriate action. In one or more embodiments, the visible output can include an image illustrating the difference in energy (or more generally, reflection magnitude) distribution between a reference radar measurement and a measured radar reflection of a body. This can assist the operator to identify the portion of the body at which the object of interest may be located so that they can take appropriate action. The location of the object of interest can be tagged on a representation of the body.

Exemplary methods of processing the radar reflections (point cloud) and processing and use of the reference point cloud according to various embodiments will now be described.

FIG. 5A is a schematic diagram illustrating a human body used as a reference body and indications of radar reflections therefrom and a centre of radar reflections for a portion of the body in accordance with embodiments.

FIG. 5B is a schematic diagram illustrating a human body carrying an object of interest having a high radar reflectivity and indications of radar reflections therefrom and a centre of radar reflections for a portion of the body in accordance with one or more embodiments.

When a cluster of measurement points are received from the objects, a location of a particular part/point on the object or a portion of the object, e.g. its centre, may be determined from the cluster of measurement point positions having regard to the intensity or magnitude of the reflections (e.g. a centre location comprising an average of the locations of the reflections weighted by their intensity or magnitude). As illustrated in FIG. 5A, the reference body has a point cloud from which its centre has been calculated and represented by the location 10, represented by the star shape. In this embodiment, the torso of the body is separately identified from the body and the centre of that portion of the body is indicated. In alternative embodiments, the body can be treated as a whole or a centre can be determined for each of more than one body part e.g. the torso and the head, for separate comparisons with centres of corresponding portions of a scanned body.

In one or more embodiments, the object's centre or portion's centre is in some embodiments a weighted centre of the measurement points. The locations may be weighted according to an Radar Cross Section (RCS) estimate of each measurement point, where for each measurement point the RCS estimate may be calculated as a constant (which may be determined empirically for the radar device) multiplied by the signal to noise ratio for the measurement divided by R⁴, where R is the distance from the radar antenna configuration to the position corresponding to the measurement point. In other embodiments, the RCS may be calculated as a constant multiplied by the signal for the measurement divided by R⁴. This may be the case, for example, if the noise is constant or may be treated as though it were constant. Regardless, the received radar reflections in the exemplary embodiments described herein may be considered as an intensity value, such as an absolute value of the amplitude of the received radar signal.

In any case, the weighted centre, WC, of the measurement points for an object may be calculated for each dimension as:

$$WC = \frac{1}{{\sum }_{n = 1}^{N} {W}_{n}} {\sum }_{n = 1}^{N} ( {W}_{n} {P}_{n} )$$

### Where:

N is the number of measurement points for the object;
Wₙ is the RCS estimate for the n^{th} measurement point; and
Pₙ is the location (e.g. its coordinate) for the n^{th} measurement point in that dimension.

From the radar measurements an RCS for an object (or a part of an object) represented by a cluster of measurement points can be estimated by summing the RCS estimates of the each of the measurement points in the cluster.

Using the radar cross section, as opposed to the magnitude of the received signal, compensates for the possibility that an object that reflects radar signals may be at any distance from the radar device. However, since the present invention is concerned with distribution of reflected energy compared to a reference distribution, in some embodiments, the magnitude of the reflective signal may be used in the above equation rather than the radar cross section. Likewise, where this specification refers to radar energy or energy distribution, radar cross sections or radar cross section distributions may alternatively be used. For example, peak and average radar cross section measurements may be used instead of peak and average energy measurements.

In some embodiments of the invention, a centre location for a scanned body or one or more centre locations for one or more corresponding portions of the scanned body can be compared with a stored data for a centre location for one or more reference bodies or one or more centre locations for one or more corresponding portions of the or each reference body. Some form of output or further processing can result when the comparison processing determines that there is a difference between the locations of at least one of the one or more centres. The difference requires to cause the output can be set as a threshold difference.

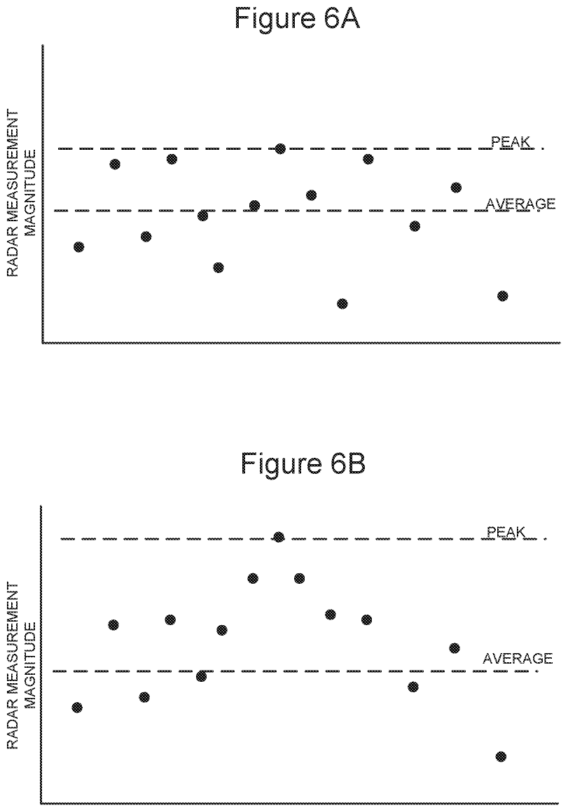

FIG. 6A is a schematic diagram illustrating the radar energy for reflections from a human body with respect to a spatial dimension (e.g. a vertical axis), used as a reference body and the determined average and peak energy using in the determination in accordance with one or more embodiments.

FIG. 6B is a schematic diagram illustrating the radar energy for reflections from a human body carrying an object of interest with respect to the same spatial dimension as FIG. 6A, and the determined average and peak energy using in the determination in accordance with one or more embodiments.

In the figures, the horizontal axis just represents the number of points. The points are displayed along the horizontal axis when in reality they occur in two dimensions. The points are displayed along the horizontal axis so that their energy or RCS (e.g. according to an RCS estimate as described above) can be plotted against the vertical axis. The average energy or average RCS for the points is shown as the lower dashed line and the peak energy or peak RCS corresponding to the point having the highest energy is shown as the upper dashed line.

It can be seen that in FIG. 6A the ratio of the peak energy to the average energy for the reference body or body portion is lower than the peak energy to the average energy for the scanned body or scanned body portion. The peak is caused by reflections from a radar reflective object of interest. The increase in or difference of the peak to average energy ratio indicates a detection of an object of interest.

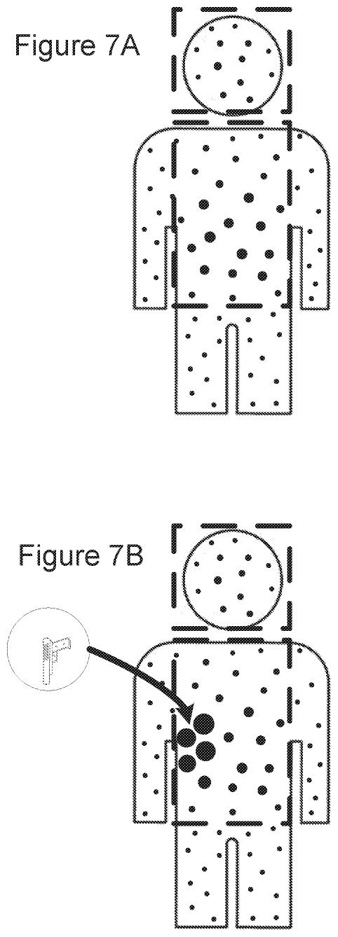

FIG. 7A is a schematic diagram illustrating a human body used as a reference body and indications of radar reflections therefrom in defined portions of the body indicated by the dashed boxes for use in radar reflection magnitude determination in accordance with embodiments.

FIG. 7B is a schematic diagram illustrating a human body carrying an object of interest having a high radar reflectivity and indications of radar reflections therefrom in defined portions of the body indicated by the dashed boxes for use in radar reflection magnitude determination in accordance with embodiments.

In embodiments of the invention portions of the body can be identified and defined separately for separate or comparative detection. The body portions can be identified from the pattern and/or number of points of radar reflections from the body. In the examples of FIGS. 7A and 7B, the portions are the torso and the head of the person indicated by the dashed boxes. From the radar reflections from the point cloud within each portion, a peak or average energy (or RCS) for each portion, or the sum of all of the energy (or RCS points) for each portion may be calculated. A ratio of the determined value of radar reflections (peak energy or RCS in some embodiments, sum of energy or RCSs in some embodiments, or average energy or RCS in some embodiments) from the two portions can be determined for the reference body and the scanned body. When a radar reflective object of interest is carried on a torso portion of the body, as illustrate in FIG. 7B, the total peak/average/summed value of the radar reflection points from the torso portion will increase causing the ratio of the magnitudes of the two regions (head and torso) to be different relative to the ratio of the magnitudes of the two regions (head and torso) for the reference object. On the other hand, when a radar absorptive object of interest is carried on a torso portion of the body, the total or average magnitude or energy of the radar reflection points from the torso portion will decrease causing the ratio of the magnitudes of the two regions (head and torso) to be different relative to the ratio of the magnitudes of the two regions (head and torso) for the reference object.

Further, in some embodiments, a plurality of ratios may be calculated, wherein each ratio represents a comparison of the value (e.g. peak/average/summed) of the received radar reflection for a different selection of body portions. For example, a first ratio may be torso to head; and a second ratio may be torso to limbs; a third radio may be limbs to head. If any one or more of these ratios differs from a corresponding reference ratio by more than a predetermined value, then it is determined that an object of interest is present on the body.

The embodiments described with reference to FIGS. 5 to 7 describe just some of the possible methods of determining parameters from the point cloud for the radar scanned object for comparison with reference parameters. A skilled person will understand that there are other methods for comparing clusters of points between to clusters and between one plurality of clusters and another plurality of clusters (one cluster for each region).

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

In addition, any priority document(s) of this application is/are hereby incorporated herein by reference in its/their entirety.

1-35. (canceled)

36. A detection apparatus comprising:
radar apparatus to direct radar signals to a body and receive radar reflections from the body; and
one or more processors to process the received radar reflections to determine a difference between a spatial distribution of the radar reflections and at least one reference to detect a presence of an object of interest as a radar reflective component of the body or a radar absorptive component of the body, wherein the at least one reference is based on a spatial distribution of radar reflections from at least one reference object;
wherein the one or more processors is configured to determine said difference by comparing a peak radar measurement magnitude to average radar measurement magnitude ratio for the radar reflections from the body with at least one reference peak radar measurement magnitude to average radar measurement magnitude ratio.

37. A detection apparatus according to claim 36, wherein each reference object comprises a human body.

38. A detection apparatus according to claim 37, wherein the body comprises a human body.

39. A detection apparatus according to claim 36, wherein the one or more processors is configured to derive the at least one reference peak radar measurement magnitude to average radar measurement magnitude ratio from a spatial distribution of radar reflections from at least a portion of at least one reference object.

40. A detection apparatus according to claim 36, wherein the one or more processors is configured to output a signal indicative of the difference.

41. A detection apparatus according to claim 40, wherein the one or more processors is configured to output the signal when the difference exceeds a threshold.

42. A detection apparatus according to claim 36, wherein the one or more processors is configured to receive a selection of at least one reference for use in the difference determination.

43. A detection apparatus according to claim 36, wherein the radar apparatus is configured to direct signals to the body and receive radar reflections from the at least a portion of the body in repeated scan frame times; and the one or more processors is configured to accumulate the radar reflections from a plurality of successive scan frame times to determine the difference between the spatial distribution of the radar reflections and the at least one reference.

44. A detection apparatus according to claim 36, comprising a handheld or wearable device.

45. The detection apparatus according to claim 36, wherein the detection apparatus is any one of: integrated onto a single chip; or a system of devices that are in wired and/or wireless communication with each other.

46. A detection method comprising:
controlling a radar apparatus to direct radar signals to a body and receive radar reflections from the body; and
processing the received radar reflections to determine a difference between a spatial distribution of the radar reflections and at least one reference to detect a presence of an object of interest as a radar reflective component of the body or a radar absorptive component of the body, wherein the at least one reference is based on a spatial distribution of radar reflections from at least one reference object.
wherein said difference is determined by comparing a peak radar measurement magnitude to average radar measurement magnitude ratio for the radar reflections from the body with at least one reference peak radar measurement magnitude to average radar measurement magnitude ratio.

47. A detection method according to claim 46, wherein each reference object comprises a human body.

48. A detection method according to claim 47, wherein the body comprises a human body.

49. A detection method according to claim 46, wherein the at least one reference peak radar measurement magnitude to average radar measurement magnitude ratio is derived from a spatial distribution of radar reflections from at least a portion of at least one reference object.

50. A detection method according to claim 46, including output a signal indicative of the difference.

51. A detection method according to claim 46, wherein the signal is output when the difference exceeds a threshold.

52. A detection method according to claim 46, including receiving a selection of at least one reference for use in the difference determination.

53. A detection method according to claim 46, including receiving radar reflections from the at least a portion of the body in repeated scan frame times, and accumulating the radar reflections from a plurality of successive scan frame times to determine the difference between the spatial distribution of the radar reflections and the at least one reference.

54. A non-transitory storage medium storing processor implementable code, which, when executed by at least one processor of a detection apparatus, causes the detection apparatus to:
control a radar apparatus to direct radar signals to a body and receive radar reflections from the body; and
process the received radar reflections to determine a difference between a spatial distribution of the radar reflections and at least one reference to detect a presence of an object of interest as a radar reflective component of the body or a radar absorptive component of the body, wherein the at least one reference is based on a spatial distribution of radar reflections from at least one reference object.
wherein the stored processor implementable code includes code, which when executed by the at least one processor, causes the detection apparatus to determine said difference by comparing a peak radar measurement magnitude to average radar measurement magnitude ratio for the radar reflections from the body with at least one reference peak radar measurement magnitude to average radar measurement magnitude ratio.

55. A non-transitory storage medium according to claim 54, wherein the stored processor implementable code includes code, which when executed by the at least one processor, causes the detection apparatus to derive the at least one reference peak radar measurement magnitude to average radar measurement magnitude ratio from a spatial distribution of radar reflections from at least a portion of at least one reference object.
